(19) United States
(12) Patent Application Publication
(10) Pub. No.: US 2025/0347626 A1
(43) Pub. Date: Nov. 13, 2025

(54) OPTICAL SENSOR MEASUREMENT MODULE, OPTICAL SENSOR MEASUREMENT SET, AND DETECTION DEVICE

(71) Applicant: Murata Manufacturing Co., Ltd., Nagaokakyo-shi (JP)

(72) Inventors: Yasuo FUJII, Nagaokakyo-shi (JP); Hiroki Ishikawa, Nagaokakyo-shi (JP); Hiroaki Ichikawa, Nagaokayo-shi (JP); Hiroki Saitou, Nagaokakyo-shi (JP)

(21) Appl. No.: 19/274,768

(22) Filed: Jul. 21, 2025

Related U.S. Application Data
(63) Continuation of application No. PCT/JP2024/002170, filed on Jan. 25, 2024.

(30) Foreign Application Priority Data
Jan. 30, 2023 (JP) 2023-011877

(51) Int. Cl. G01N 21/64; G01N 21/01

(52) U.S. Cl. CPC G01N 21/645; G01N 2021/0106

(57) ABSTRACT

An optical sensor measurement module that includes: a board having a surface; a light emitting element on the surface of the board; and a light receiving element on the surface of the board, wherein the light emitting element is configured to irradiate an optical sensor with excitation light, and the light receiving element is configured to receive sensor light that is fluorescently emitted from the optical sensor.

### CROSS REFERENCE TO RELATED APPLICATIONS

The present application is a continuation of International application No. PCT/JP2024/002170, filed Jan. 25, 2024, which claims priority to Japanese Patent Application No. 2023-011877, filed Jan. 30, 2023, the entire contents of each of which are incorporated herein by reference.

### TECHNICAL FIELD

The present disclosure relates to an optical sensor measurement module, an optical sensor measurement set, and a detection device.

### BACKGROUND ART

Patent Document 1 discloses a method, a vessel, and a device for observing metabolic activity of culture cells in liquid media. The method described above is a method for observing metabolic activity of cells cultured in a liquid medium, in which: the cells are received in vessels having a part permeable to mass transport of oxygen into the liquid medium, the oxygen concentration is measured optically with the aid of sensor membranes in the liquid medium positioned between the cultivated cells and the part of the vessel which is dominantly permeable to oxygen transport into the liquid medium, and the oxygen concentration measured in the liquid medium is compared with an oxygen concentration value measured in a reference vessel containing only liquid medium without cells, and/or an oxygen concentration value calculated by means of measured values of other parameters.
Patent Document 1: Japanese Patent Application Laid-Open No. 2002-534997

### SUMMARY OF THE DISCLOSURE

FIGS. 1 to 4 and the like of Patent Document 1 indicate: disposing an optical sensor chip inside a culture vessel filled with a medium; measuring an optical signal of the optical sensor chip with an optical fiber, from the outside of the culture vessel; and exchanging excitation light and sensor light with one optical fiber, and separating the excitation light and the sensor light with a beam splitter. Light emission of the optical sensor chip changes according to a dissolved oxygen concentration in the medium. Therefore, the dissolved oxygen concentration can be determined by measuring the change in light emission of the optical sensor chip.

However, in the disclosure described in Patent Document 1, since measurement is performed using the optical fiber, there is a problem that a space is required in a direction perpendicular to an irradiation surface of the excitation light. Furthermore, the disclosure described in Patent Document 1 also has a problem that connection of the optical fiber becomes complicated as the number of sensors increases.

The present disclosure has been made to solve the above problems, and an object of the present disclosure is to provide an optical sensor measurement module that can also be installed in a narrow space and can obtain a large received light intensity. Further, an object of the present disclosure is to provide an optical sensor measurement set and a detection device including the optical sensor measurement module.

An optical sensor measurement module according to the present disclosure includes: a board having a surface; a light emitting element on the surface of the board; and a light receiving element on the surface of the board, wherein the light emitting element is configured to irradiate an optical sensor with excitation light, and the light receiving element is configured to receive sensor light that is fluorescently emitted from the optical sensor.

An optical sensor measurement set according to the present disclosure includes: the optical sensor measurement module according to the present disclosure; and a positioning jig for adjustment of a position of the optical sensor measurement module with respect to an optical sensor, in which the positioning jig includes a frame body surrounding a through hole.

A detection device according to the present disclosure includes: the optical sensor measurement module according to the present disclosure disposed outside a container having light transmissivity; and an optical sensor disposed inside the container to face the optical sensor measurement module.

According to the present disclosure, it is possible to provide an optical sensor measurement module that can also be installed in a narrow space and can obtain a large received light intensity. Furthermore, according to the present disclosure, it is possible to provide an optical sensor measurement set and a detection device including the optical sensor measurement module.

### BRIEF EXPLANATION OF THE DRAWINGS

FIG. 1 is a sectional view schematically illustrating an example of an optical sensor measurement module of the present disclosure.

FIG. 2 is a plan view schematically illustrating an example of the optical sensor measurement module of the present disclosure.

FIG. 3 is a sectional view schematically illustrating an example of a detection device including the optical sensor measurement module of the present disclosure.

FIG. 4 is a plan view schematically illustrating an example of the optical sensor measurement module in which two light receiving elements are disposed on one surface of a board.

FIG. 5 is a plan view schematically illustrating an example of the optical sensor measurement module in which two light emitting elements are disposed on one surface of the board.

FIG. 6 is a schematic diagram illustrating an example of the optical sensor measurement module including a phase comparator.

FIG. 7 is a perspective view schematically illustrating an example of the optical sensor measurement module used in combination with a positioning jig.

### DESCRIPTION OF THE PREFERRED EMBODIMENTS

Hereinafter, an optical sensor measurement module, an optical sensor measurement set, and a detection device of the present disclosure will be described. The present disclosure is not limited to the following configuration, and may be modified as appropriate without changing the gist of the present disclosure. The present disclosure also includes a combination of a plurality of individual preferable configurations described below.

In the present specification, the terms indicating the relationship between elements (for example, “vertical”, “parallel”, and “orthogonal”) and the terms indicating the shape of an element are not expressions indicating only a strict meaning, but are expressions meaning to include a substantially equivalent range, for example, a difference of about several %.

The drawings illustrated below are schematic views, and dimensions, scales of aspect ratios, and the like may be different from those of actual products. In the drawings, the same or corresponding parts are denoted by the same reference numerals. In each drawing, the same elements are denoted by the same reference numerals, and redundant description will be omitted.

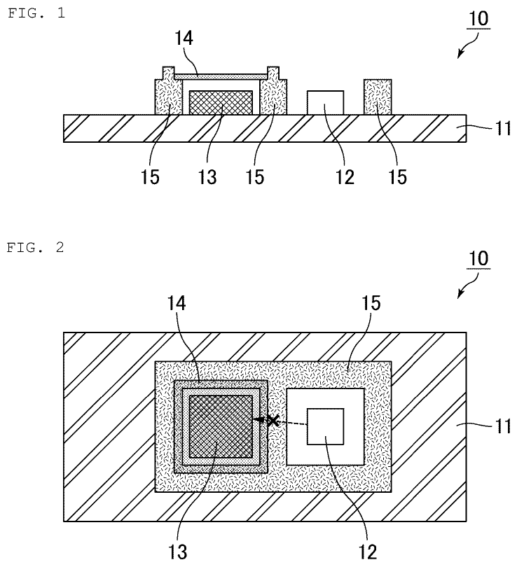

FIG. 1 is a sectional view schematically illustrating an example of an optical sensor measurement module of the present disclosure. FIG. 2 is a plan view schematically illustrating an example of the optical sensor measurement module of the present disclosure.

An optical sensor measurement module 10 illustrated in FIGS. 1 and 2 includes a board 11, and a light emitting element 12 and a light receiving element 13 disposed on one surface (an upper surface of the board 11 in FIG. 1) of the board 11. Preferably, the optical sensor measurement module 10 further includes a filter 14 and a wall portion 15.

Although not illustrated in FIGS. 1 and 2, the optical sensor measurement module 10 further includes a drive circuit of the light emitting element 12 and an amplifier circuit that amplifies a current output from the light receiving element 13. Note that the drive circuit and the amplifier circuit may not be disposed on the one surface of the board 11. For example, the drive circuit and the amplifier circuit may be disposed on another surface of the board 11 (a lower surface of the board 11 in FIG. 1), or may be disposed on a board different from the board 11.

FIG. 3 is a sectional view schematically illustrating an example of a detection device including the optical sensor measurement module of the present disclosure.

A detection device 100 illustrated in FIG. 3 includes the optical sensor measurement module 10 and an optical sensor 20. The optical sensor measurement module 10 is disposed outside a container 30 having light transmissivity. Whereas, the optical sensor 20 is disposed inside the container 30 so as to face the optical sensor measurement module 10.

As illustrated in FIG. 3, in the optical sensor measurement module 10, the light emitting element 12 is configured to irradiate the optical sensor 20 with excitation light, and the light receiving element 13 is configured to receive the sensor light that is fluorescently emitted from the optical sensor 20.

In the detection device 100 illustrated in FIG. 3, for example, metabolism of cells (not illustrated) cultured in a medium 31 in the container 30 can be monitored. Similarly to Patent Document 1, since light emission of the optical sensor 20 changes according to a dissolved oxygen concentration in the medium 31, the dissolved oxygen concentration can be determined by measuring the change in light emission of the optical sensor 20. In this case, the container 30 may be a small container such as a petri dish or a flask, or may be a large container used in a bioreactor or the like.

For example, in a bioreactor, since it is difficult to clean an inside of the container, a single use bag (disposable bag) to be used only once is used as the container, without reusing the container. Since such a single use bag usually has flexibility, at the time of use, the single use bag is accommodated and fixed in a housing containing stainless steel (SUS) or the like and including a bottomed cylindrical container whose upper end is opened.

As illustrated in FIGS. 1 to 3, in the optical sensor measurement module 10, the light emitting element 12 and the light receiving element 13 are disposed on one surface of the board 11, so that a thin planar structure can be obtained. Therefore, the optical sensor measurement module 10 can also be installed in a narrow space. Accordingly, for example, the structure of the present disclosure can be used in a single use bag or the like in which a gap between the housing and the container is narrow.

Furthermore, in the optical sensor measurement module 10, by irradiating a wider area than an optical fiber with the excitation light, the optical sensor 20 is caused to fluorescently emit light in a wide area, so that a large received light intensity can be obtained.

As illustrated in FIG. 2, an area of the light receiving element 13 is preferably larger than an area of the light emitting element 12, when viewed from a thickness direction of the board 11. The area mentioned here means an area of an outer shape. By making the area of the light receiving element 13 larger than the area of the light emitting element 12, the sensor light can be received in a wide area, so that a large received light intensity can be obtained.

As illustrated in FIGS. 1 and 3, the optical sensor measurement module 10 preferably further includes the filter 14 capable of transmitting the sensor light, on a side of the light receiving element 13 opposite to the board 11 (an upper side of the light receiving element 13 in FIGS. 1 and 3). The filter 14 can prevent excitation scattered light from being mixed into the light receiving element 13.

The filter 14 capable of transmitting the sensor light may be disposed on the wall portion 15. In other words, the filter 14 may be supported by the wall portion 15. Alternatively, the filter 14 may be formed as a thin film on the upper surface of the light receiving element 13.

Although not illustrated in FIGS. 1 and 3, the optical sensor measurement module 10 may further include a filter capable of transmitting the excitation light, on a side of the light emitting element 12 opposite to the board 11 (an upper side of the light emitting element 12 in FIGS. 1 and 3). In that case, by cutting light of an unnecessary color included in the light emitting element 12, the optical sensor 20 can be operated with high accuracy. In particular, when light of the light emitting element 12 and the sensor light have wavelengths close to each other, the light and the sensor light can be separated by the filter.

The filter capable of transmitting the excitation light may be disposed on the wall portion 15, or may be formed as a thin film on the upper surface of the light emitting element 12.

As illustrated in FIGS. 1 to 3, the optical sensor measurement module 10 preferably further includes the wall portion 15 at least between the light emitting element 12 and the light receiving element 13, on one surface of the board 11. The wall portion 15 can prevent the excitation light emitted from the light emitting element 12 from being directly mixed into the light receiving element 13 from a lateral direction (see an arrow in FIG. 2).

A material contained in the wall portion 15 is not particularly limited as long as the material does not transmit light, and examples thereof include a metal material, a resin material, and an inorganic material (graphite, ceramics, and the like).

As illustrated in FIG. 2, the wall portion 15 preferably surrounds the light receiving element 13. In this case, unnecessary light from an outside can be blocked.

Furthermore, the wall portion 15 may surround the light emitting element 12. As illustrated in FIG. 2, the wall portion 15 may be disposed in a frame shape along an outer periphery of the board 11.

As illustrated in FIG. 1, a height of the light emitting element 12 is preferably lower than that of the wall portion 15. Similarly, a height of the light receiving element 13 is preferably lower than that of the wall portion 15.

A step may be provided on an upper surface of the wall portion 15. As illustrated in FIG. 1, preferably, the step is provided on the upper surface of the wall portion 15 surrounding the light receiving element 13, and the filter 14 is provided on the step. As a result, light incidence from a side surface of the filter 14 is suppressed.

The optical sensor measurement module of the present disclosure preferably further includes a transmitter that transmits an electric signal obtained from the sensor light to a control terminal outside the module. In particular, the transmitter preferably wirelessly transmits an electrical signal obtained from the sensor light. Wireless transmission eliminates necessity of connection by wiring.

The transmitter may or may not be disposed on one surface of the board on which the light emitting element and the light receiving element are disposed. For example, the transmitter may be disposed on another surface of the board on which the light emitting element and the light receiving element are disposed, or may be disposed on a board different from the board on which the light emitting element and the light receiving element are disposed.

The optical sensor measurement module of the present disclosure may be configured to detect an intensity of the sensor light. In this case, since signal processing is simple, processing can be performed with a circuit with low processing capability. Therefore, it is possible to reduce a size and power consumption of a signal processing circuit.

The optical sensor measurement module of the present disclosure may be configured to calculate a dissolved oxygen concentration from an intensity of the sensor light. In this case, the transmitter transmits dissolved oxygen concentration data.

In the optical sensor measurement module of the present disclosure, two or more light receiving elements may be disposed on one surface of the board.

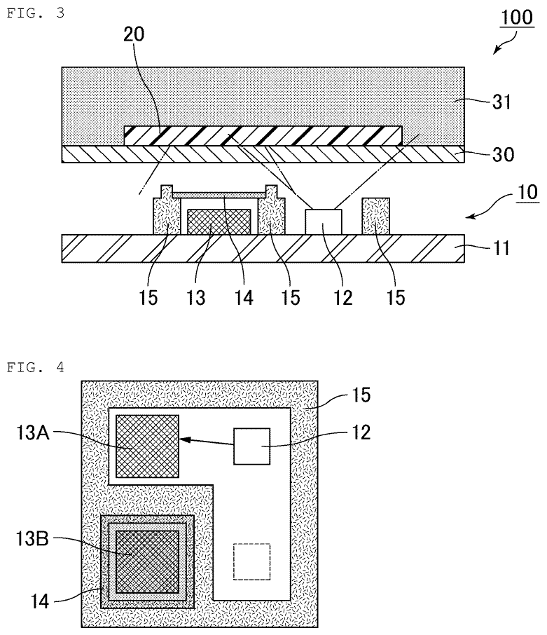

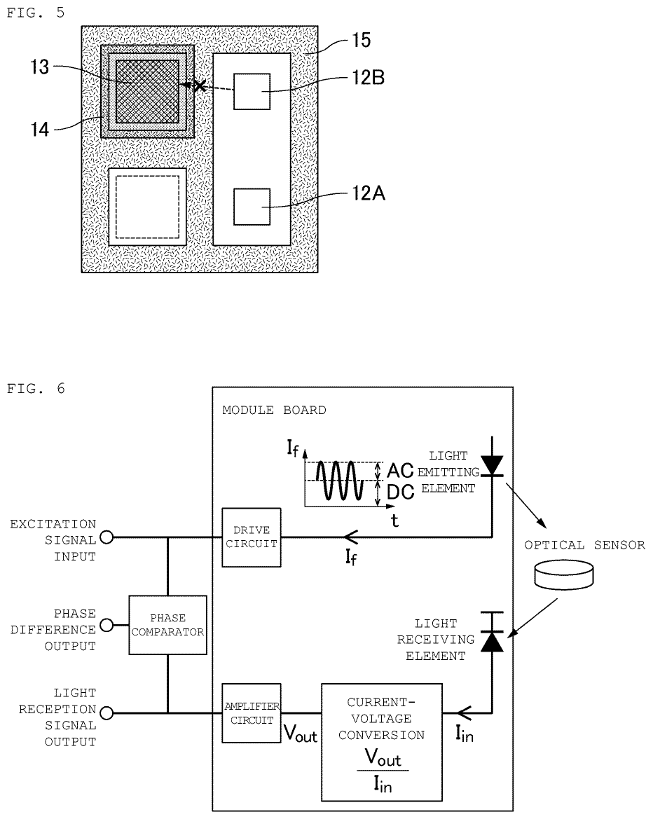

FIG. 4 is a plan view schematically illustrating an example of the optical sensor measurement module in which two light receiving elements are disposed on one surface of the board.

For example, excitation scattered light of the light emitting element 12 is taken into a first light receiving element 13A as reference light, and the sensor light is received by a second light receiving element 13B. In this case, the first light receiving element 13A reflects a state of an optical transmission path. Therefore, an intensity change of the sensor light can be determined with a ratio between the first light receiving element 13A and the second light receiving element 13B.

As described above, when two or more light receiving elements are disposed on one surface of the board, a sensor light intensity is detected on the basis of an intensity of reference light, so that a scale of the signal processing circuit can be reduced.

In addition, when two or more light receiving elements are disposed on one surface of the board, sensing can be performed for a plurality of items.

In the optical sensor measurement module of the present disclosure, two or more light emitting elements may be disposed on one surface of the board.

FIG. 5 is a plan view schematically illustrating an example of the optical sensor measurement module in which two light emitting elements are disposed on one surface of the board.

For example, when the optical sensor does not emit light with light emitted from a first light emitting element 12A, the light receiving element 13 receives scattered light of the first light emitting element 12A as reference light. Whereas, when the optical sensor is excited by light emitted from a second light emitting element 12B to emit light, the sensor light is received by the light receiving element 13. In this case, the first light emitting element 12A reflects a state of an optical transmission path. Therefore, an intensity change of the sensor light can be determined with a ratio between the time of irradiation of the first light emitting element 12A and the time of irradiation of the second light emitting element 12B.

As described above, when two or more light emitting elements are disposed on one surface of the board, a sensor light intensity is detected on the basis of the intensity of the reference light, so that a scale of the signal processing circuit can be reduced.

In addition, when two or more light emitting elements are disposed on one surface of the board, sensing can be performed for a plurality of items.

In the optical sensor measurement module of the present disclosure, when two or more light receiving elements are disposed on one surface of the board, one light emitting element may be disposed or two or more light emitting elements may be disposed on the one surface of the board. Similarly, when two or more light emitting elements are disposed on one surface of the board, one light receiving element may be disposed or two or more light receiving elements may be disposed on the one surface of the board.

The optical sensor measurement module of the present disclosure may be configured to detect a phase difference between the excitation light modulated by a sine wave and the sensor light. In an optical sensor, it is known that not only a fluorescence intensity changes but also a fluorescence lifetime changes, in accordance with a dissolved oxygen concentration. By detecting the phase difference, the change in the fluorescence lifetime can be observed. The detection of the phase difference is less affected by disturbance than the detection of the light intensity.

For example, the optical sensor measurement module of the present disclosure may further include a phase comparator (also simply referred to as a phase shifter).

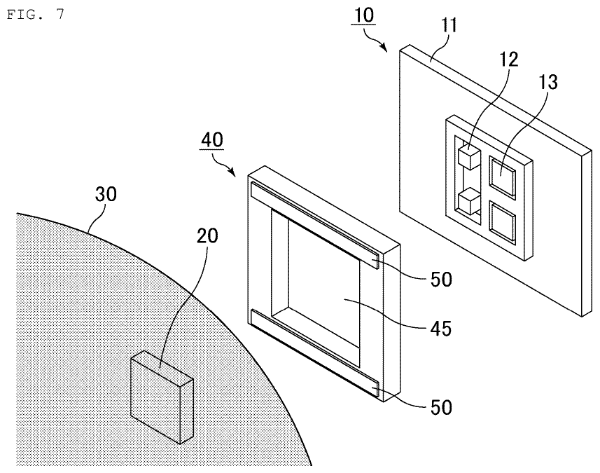

FIG. 6 is a schematic diagram illustrating an example of the optical sensor measurement module including the phase comparator.

As illustrated in FIG. 6, a phase difference between the excitation light modulated with a sine wave and the sensor light may be detected using the phase comparator.

Alternatively, it is also possible to modulate the excitation light with a sine wave and detect the phase difference between the excitation light and the sensor light by using software without using the phase comparator. For example, fast Fourier transform (FFT) processing may be performed.

The optical sensor measurement module of the present disclosure may be configured to calculate a dissolved oxygen concentration from the detected phase difference.

The optical sensor measurement module of the present disclosure may be used in combination with a positioning jig. The positioning jig can accurately adjust a position of the optical sensor measurement module with respect to the optical sensor. Specifically, the light emitting element and the light receiving element of the optical sensor measurement module can be caused to face the optical sensor at an optimum position.

FIG. 7 is a perspective view schematically illustrating an example of the optical sensor measurement module used in combination with the positioning jig.

As illustrated in FIG. 7, a positioning jig 40 is fixed between the optical sensor measurement module 10 and the container 30. The positioning jig 40 is fixed to the container 30 with a fixing means such as a double-sided tape 50 interposed therebetween. Similarly, the optical sensor measurement module 10 is fixed to the positioning jig 40 with a fixing means such as a double-sided tape interposed therebetween. Note that, the individual fixing means are not particularly limited, and may be the same as or different from each other.

The positioning jig 40 includes a frame body surrounding a through hole 45. A shape of the through hole 45 is not particularly limited. Similarly, an outer shape of the frame body is not particularly limited. A shape of an outer edge of the frame body may be the same as or different from a shape of an inner edge of the frame body (that is, the shape of the through hole 45). A material contained in the frame body is not particularly limited, and may be a material that transmits light or a material that does not transmit light.

When viewed from a thickness direction of the board 11, the through hole 45 of the positioning jig 40 is located at a position overlapping with the light emitting element 12 and the light receiving element 13 of the optical sensor measurement module 10, and overlapping with the optical sensor 20.

By using the through hole 45, the position of the positioning jig 40 with respect to the optical sensor 20 can accurately be determined. Therefore, the light emitting element 12 and the light receiving element 13 of the optical sensor measurement module 10 can be caused to face the optical sensor 20 at an optimum position.

The optical sensor measurement module, the optical sensor measurement set, and the detection device of the present disclosure are not limited to the above embodiment. For example, various applications and modifications can be made within the scope of the present disclosure regarding the configurations, manufacturing conditions, and the like of the board, the light emitting element, the light receiving element, the optical sensor, and the container.

### DESCRIPTION OF REFERENCE SYMBOLS

10: Optical sensor measurement module
11: Board
12: Light emitting element
12A: First light emitting element
12B: Second light emitting element
13: Light receiving element
13A: First light receiving element
13B: Second light receiving element
14: Filter
15: Wall portion
20: Optical sensor
30: Container
31: Medium
40: Positioning jig
45: Through hole
50: Double-sided tape
100: Detection device

1. An optical sensor measurement module comprising:
a board having a surface;
a light emitting element on the surface of the board; and
a light receiving element on the surface of the board,
wherein the light emitting element is configured to irradiate an optical sensor with excitation light, and
the light receiving element is configured to receive sensor light that is fluorescently emitted from the optical sensor.

2. The optical sensor measurement module according to claim 1, wherein the optical sensor measurement module separate from the optical sensor.

3. The optical sensor measurement module according to claim 1, wherein an area of the light receiving element is larger than an area of the light emitting element when viewed from a thickness direction of the board.

4. The optical sensor measurement module according to claim 1, further comprising a filter capable of transmitting the sensor light, the filter being positioned on a side of the light receiving element opposite to the board.

5. The optical sensor measurement module according to claim 1, further comprising a wall portion at least between the light emitting element and the light receiving element on one surface of the board.

6. The optical sensor measurement module according to claim 5, wherein the wall portion surrounds the light receiving element.

7. The optical sensor measurement module according to claim 6, wherein the wall portion surrounds the light emitting element.

8. The optical sensor measurement module according to claim 5, wherein the wall portion surrounds the light emitting element.

9. The optical sensor measurement module according to claim 2, further comprising a wall portion at least between the light emitting element and the light receiving element on one surface of the board.

10. The optical sensor measurement module according to claim 9, wherein the wall portion supports the filter.

11. The optical sensor measurement module according to claim 1, wherein two or more of the light receiving elements are on the surface of the board.

12. The optical sensor measurement module according to claim 11, wherein two or more of the light emitting elements are on the surface of the board.

13. The optical sensor measurement module according to claim 1, wherein two or more of the light emitting elements are on the surface of the board.

14. The optical sensor measurement module according to claim 1, wherein the optical sensor measurement module is configured to detect an intensity of the sensor light.

15. The optical sensor measurement module according to claim 1, wherein the optical sensor measurement module is configured to detect a phase difference between the sensor light and the excitation light that is modulated with a sine wave.

16. The optical sensor measurement module according to claim 1, further comprising a transmitter that transmits an electric signal obtained from the sensor light.

17. An optical sensor measurement set comprising:
the optical sensor measurement module according to claim 1; and
a positioning jig for adjustment of a position of the optical sensor measurement module with respect to an optical sensor,
wherein the positioning jig includes a frame body surrounding a through hole.

18. A detection device comprising:
the optical sensor measurement module according to claim 1 disposed outside a container having light transmissivity; and
an optical sensor disposed inside the container to face the optical sensor measurement module.

19. The detection device according to claim 18, further comprising:
a positioning jig between the optical sensor measurement module and the container,
wherein the positioning jig includes a frame body surrounding a through hole, and
when viewed from a thickness direction of the board, the through hole of the positioning jig is located at a position overlapping with the light emitting element and the light receiving element of the optical sensor measurement module and overlapping with the optical sensor.
